(19) United States
(12) Patent Application Publication
(10) Pub. No.: US 2017/0024447 A1
(43) Pub. Date: Jan. 26, 2017

(54) SYSTEM, METHOD, AND APPARATUS FOR COLLABORATIVE EDITING OF COMMON OR RELATED COMPUTER BASED SOFTWARE OUTPUT

(71) Applicant: Brigham Young University, Provo, UT (US)

(72) Inventors: Kelly Eric Bowman, Jr., Provo, UT (US); Walter Edward Red, Provo, UT (US); Charles Gregory Jensen, Provo, UT (US); Ammon Hepworth, Provo, UT (US); Joshua Coburn, Provo, UT (US)

(21) Appl. No.: 15/068,465

(22) Filed: Mar. 11, 2016

Related U.S. Application Data
(60) Provisional application No. 62/131,388, filed on Mar. 11, 2015.

(51) Int. Cl. G06F 17/30

(52) U.S. Cl. CPC G06F 17/30569; G06F 17/30312

(57) ABSTRACT

A system includes a collaborative data store that stores an object which can comprise a description, model, representation, arrangement or composition created by one or more contributors, the object comprising a plurality of features, the object encoded in a vendor-neutral format, a collaborative server configured to manage the collaborative data store, a first computer or electronic device client comprising at least one processor and configured to execute a first software application and enable the first user to edit the content of the object encoded in a first proprietary format that is different than the vendor-neutral format. The first computer or electronic device client and the collaborative server may be collectively configured to detect updates to the content of the object encoded in the first proprietary format, convert the updates to feature changes and update the object encoded in the vendor-neutral format with the feature changes.

### CROSS-REFERENCE TO RELATED APPLICATIONS

This application claims priority to U.S. provisional application 62/131,388 entitled “System, Method, and Apparatus for Collaborative Editing of Common or Related Computer Based Software Output” and filed on 11 Mar. 2015. The foregoing application is incorporated herein by reference.

### BACKGROUND

The concepts presented herein are not limited to engineering objects, CAx applications or CAx clients and can be implemented in any computer based tool that creates an object of any kind that is uniquely defined in a software application either through proprietary or non-proprietary software descriptions representing a vendor specific format. It only requires that the first object can be created with similar fidelity, form and function in a second software application either through proprietary or non-proprietary software descriptions representing a second vendor specific format. Through the algorithms presented herein discuss an agnostic CAx approach (e.g. see FIG. 4 and the associated description), a generic object that is defined by two different vendor specific formats can be put into a multi user data base. In this data base it can be accessed and manipulated by multiple different vendor platforms in a multiuser mode and be represented to each computer client in the software definition they are using to attach to the database

Examples of common potential applications that could exploit the subject matter herein include office software applications such as word processing or spreadsheets, photo editing software, music writing software, etc. All of these examples fall outside of traditional CAx applications.

### SUMMARY

A system includes a collaborative data store that stores an object which can comprise a description, model, representation, arrangement or composition created by one or more contributors, the object comprising a plurality of features, the object encoded in a vendor-neutral format, a collaborative server configured to manage the collaborative data store, a first computer or electronic device client comprising at least one processor and configured to execute a first software application and enable the first user to edit the content of the object encoded in a first proprietary format that is different than the vendor-neutral format. The first computer or electronic device client and the collaborative server may be collectively configured to detect updates to the content of the object encoded in the first proprietary format, convert the updates to feature changes and update the object encoded in the vendor-neutral format with the feature changes.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting one example of a computing and communications infrastructure;

FIG. 2 is a schematic diagram depicting one example of a collaborative CAx editing system;

FIG. 3 is a flowchart diagram depicting one example of a collaborative CAx editing method; and

FIG. 4 is a schematic diagram depicting one example of a collaborative CAx editing system.

### DETAILED DESCRIPTION OF THE INVENTION

Some of the functional units described in this specification have been labeled as modules, in order to more particularly emphasize their implementation independence. Others are assumed to be modules. For example, a module or similar unit of functionality may be implemented as a hardware circuit comprising custom VLSI circuits or gate arrays, off-the-shelf semiconductors such as logic chips, transistors, or other discrete components. A module may also be implemented with programmable hardware devices such as field programmable gate arrays, programmable array logic, programmable logic devices or the like.

A module or a set of modules may also be implemented (in whole or in part) as a processor configured with software to perform the specified functionality. An identified module may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, the executable code of a module may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any tangible form capable of enabling execution of a program of machine-readable instructions on a digital processing apparatus. For example, a computer readable medium may be embodied by a flash drive, compact disk, digital-video disk, a magnetic tape, a Bernoulli drive, a magnetic disk, a punch card, flash memory, integrated circuits, or other digital processing apparatus memory device. A digital processing apparatus such as a computer may store program codes, associated data, and the like on the computer readable medium that when retrieved enable the digital processing apparatus to execute the functionality specified by the modules.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

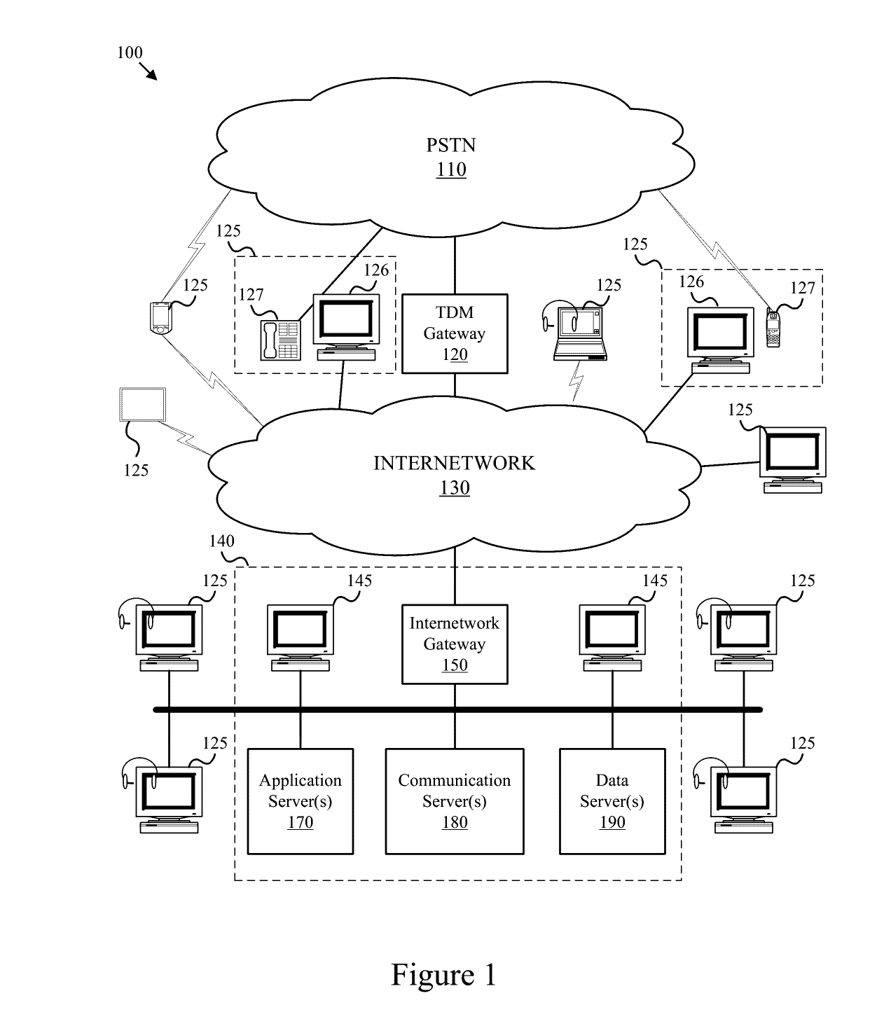

FIG. 1 is a block diagram of one example of a computing and communications infrastructure 100 that is consistent with one or more embodiments of the claimed invention. As depicted, the infrastructure 100 includes various systems, subsystems, and networks such as a public switched telephone network (PSTN) 110, a TDM gateway 120 connecting the PSTN to an inter-network 130, a variety of workstations 125, a data center 140 with administrative terminals 145, an inter-network gateway 150 connecting a local area network to the inter-network 130, and various servers such as application servers 170, communication servers 180, and data servers 190. The infrastructure 100 is one example of components that can be operably interconnected to provide an infrastructure for a collaborative CAx editing system that facilitates computer-aided design, computer-aided engineering, computer-aided manufacturing, and the like.

Each workstation 125 may include a separate computing device 126 and a communications device 127 or the computing device and communications device may integrated into the workstation 125. Examples of the communications device 127 include a phone, a VOIP device, an instant messaging device, a texting device, a browsing device, and the like. The computing devices 126 may enable graphical viewing, selection, and editing. The communications devices 127 may enable users to communicate with other CAx system users.

The inter-network 130 may facilitate electronic communications between the various workstations and servers. In one embodiment, the inter-network 130 is the internet. In another embodiment, the inter-network 130 is a virtual private network (VPN).

Various servers such as blade servers within the data center 140 function cooperatively to facilitate concurrent collaborative editing of CAx models by local and remote users. For example, the application servers 170 may provide one or more CAx applications to the local and remote users. Some users may have the CAx applications installed on their local computing devices 126. Examples of CAx applications include Siemens NX, MSC Nastran, Dessault Systems CATIA and Solidworks, ANSYS, and the like.

The communication servers 180 may facilitate communications between the users through various channels or services such as VOIP services, email services, instant messaging services, short message services, and text messaging services. The workstations 125 may leverage such services for user to user communications via the communication servers 180 or via other available service platforms.

The data servers 190 or the like may store CAx models within various model files or records. The data servers may replicate copies of the models for use by various users. Some users may have a local copy of a model. As described herein, instead of requiring a particular user to assume control of a model file or record, updates to the model may be coordinated by one or more CAx applications including client versions, server versions, and cloud versions of such applications.

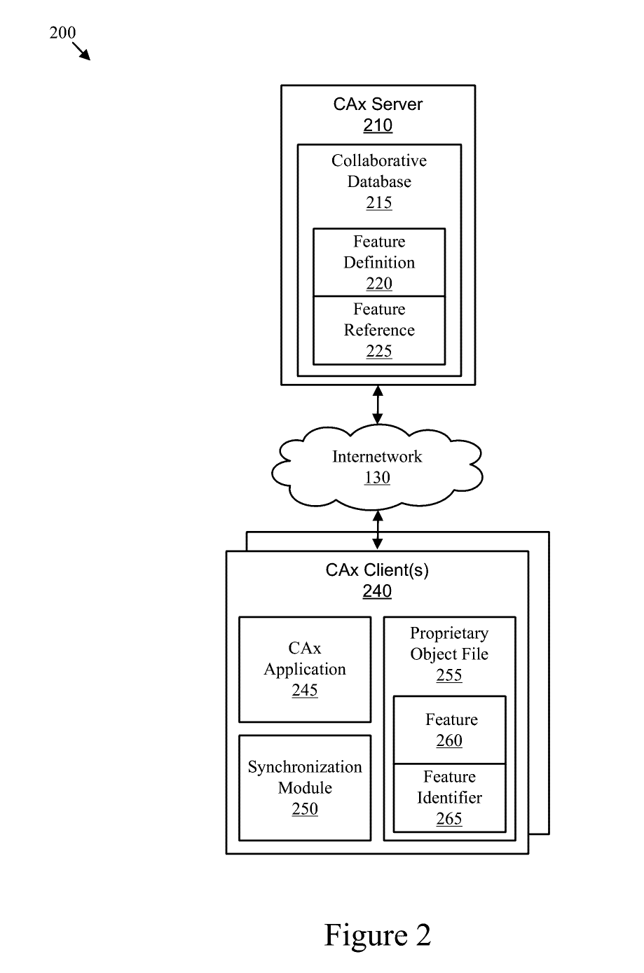

FIG. 2 is a block diagram of one example of a collaborative CAx editing system 200 that is consistent with one or more embodiments of the claimed invention. As depicted, and as will be explained in greater detail below, the collaborative CAx editing system 200 may include one or more CAx clients 240 with at least one processor configured to execute a proprietary CAx application 245 and enable editing of a model of an engineering object by a user. The model of the engineering object may be encoded in a proprietary format on each client 240 and reside in the proprietary object file 255. The proprietary CAx application 245 and the associated proprietary format of the object file 255 may be different on each client 240.

The collaborative CAx editing system 200 may also include a collaborative CAx server 210 that stores an operations log of the engineering object within a collaborative data store 215. In the depicted embodiment, the collaborative data store 215 is a database. A synchronization module 250 may detect creation of a proprietary feature 260 of the engineering object within the proprietary CAx application 245 and insert a feature identifier 265 corresponding to the feature within the model of the engineering object encoded in the proprietary format and stored in the proprietary object file 255. The feature identifier 265 may correspond to, or be identical to, the feature reference 225.

The proprietary object file 255 and the collaborative data store 215 may reside on a single storage device or may be distributed across multiple storage devices. The storage devices may, or may not be proximate to the CAx client(s) 240 and the CAx server 210. For example, the collaborative data store 215 may represent portions of the computing and communications infrastructure 100 in FIG. 1. Furthermore, each of the depicted modules such as the CAx application 245 and the synchronization module 250 may reside on a single computing device (i.e. node) or be collaboratively partitioned onto multiple devices or nodes.

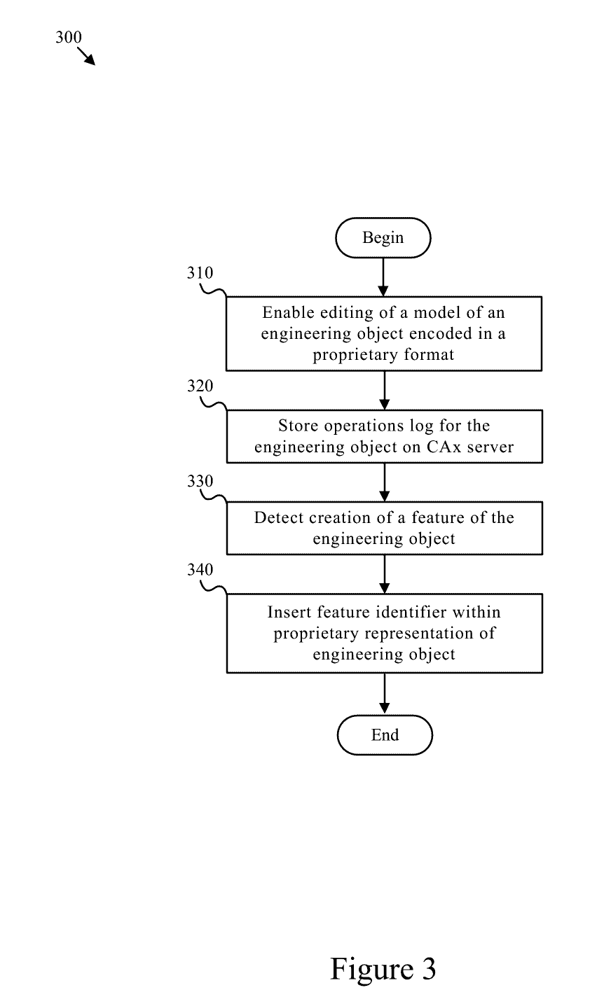

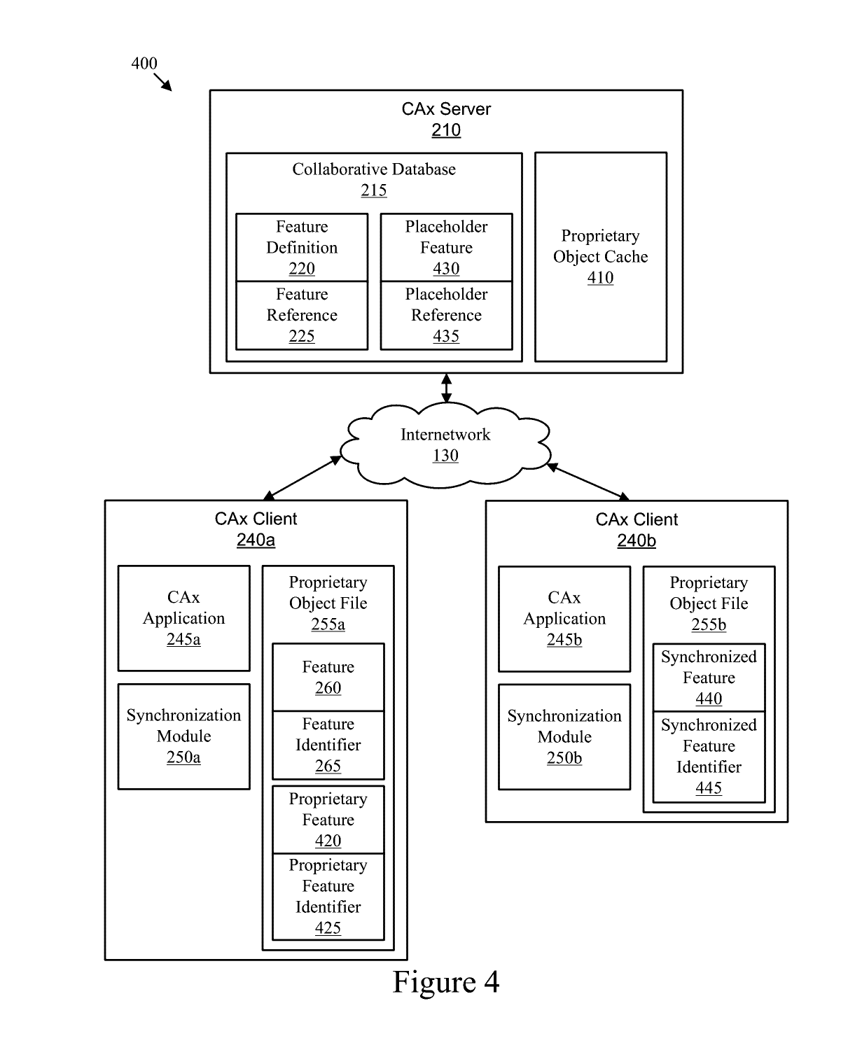

FIG. 3 is a flow diagram of a collaborative CAx editing method 300. The steps (i.e., operations) shown in FIG. 3 may be performed by any suitable computer-executable code and/or computing system and in some cases need not be executed sequentially or in the depicted order. In some embodiments, the operations shown in FIG. 3 may be performed by one or more components of computing and communications infrastructure 100 in FIG. 1, system 200 in FIG. 2, and/or system 400 in FIG. 4.

As illustrated in FIG. 3, at step 310 one or more of the CAx clients described herein may execute a proprietary CAx application and enable editing of a model of an engineering object encoded in a proprietary format. For example, at step 310 the CAx client 240 may, as part of the system 200 in FIG. 2, execute the CAx application 245 and enable editing of a model of an engineering object encoded in a proprietary format by a user. The CAx application 245 may store the model of the engineering object in the proprietary object file 255. The model may include one or more features of the engineering object, such as proprietary feature 260.

As used herein, the phrase “engineering object” generally refers to a conceptual design produced to show the look or function of an object before it is built or made. The design may be incorporated in representations such as plans, drawings, diagrams, schematics, blueprints, sketches, maps, or models. The design may include one or more “features,” e.g., attributes of an engineering object and/or operations that receive various parameters and generate one or more geometric elements. For example, an extrude feature may operate on a 2D sketch and generate multiple geometric faces therefrom.

As used herein, the phrase “proprietary representation” generally refers to a data format associated with a CAx application. A proprietary representation of an engineering object may be vendor specific and typically cannot be directly edited by a CAx application other than those available from the vendor or licensed by the vendor. Typically, a conversion process is required for a CAx application from another vendor to edit the engineering object. The conversion process may result in the loss of data.

At step 320 an operations log for the engineering object is stored on a collaborative CAx server. For example, at step 320 collaborative CAx server 210 may, as part of the system 200 in FIG. 2, store an operations log of the engineering object on a collaborative CAx server 210. The operations log may be stored in a collaborative database 215, and may include one or more feature definitions, such as feature definition 220.

As used herein, the phrase “operations log” generally refers to a log of CAx operations that may or may not be associated with a single proprietary CAx application. For example, the operations log may be a vendor-neutral log of feature definitions that facilitates collaborate editing between various proprietary CAx applications.

The collaborative CAx server 210 may store an operations log of the engineering object in various ways. In one embodiment, the operations log of the engineering object comprises a log of sequentially-generated feature definitions. The engineering object may be reconstructed within various CAx applications by regenerating the features comprising the engineering object in sequence. The feature definitions within the operations log may be readily translatable to editing commands within each CAx application by a synchronization module 250 associated therewith.

The operations log of the engineering object may include references to features within the proprietary representation of the engineering object. For example, as depicted in FIG. 2, the feature definition 220, corresponding to the proprietary feature 260 and to the feature identifier 265, may have an associated feature reference 225 associating the feature definition 220 with the proprietary feature 260. In some embodiments, the feature identifier 265, corresponds directly to the feature reference 225. In one embodiment, the feature identifier 265 and the feature reference 225 are identical. The synchronization module 250 may use feature reference 225 to identify the corresponding proprietary feature 260 within the proprietary object file 255 via the feature identifier 265. In one embodiment, the feature reference 225 is a globally-unique identifier (GUID) associated with the proprietary feature 260.

In one embodiment, the proprietary representation of the engineering object corresponds to a point-in-time within the log of sequentially-generated feature definitions. The point-in-time may correspond to a snapshot or revision marker within the log. In a collaborative CAx editing environment, editing of the engineering object may take place while a client is offline. The sequentially-generated feature definitions may continue to be created in the operations log of the engineering object. When the client reconnects with the operations log of the engineering object, subsequently-generated feature definitions created after the point-in-time are applied to the proprietary representation to synchronize the proprietary representation with the operations log.

Returning to FIG. 3, at step 330 one or more of the CAx clients 240 may detect creation of a feature of the engineering object within the proprietary CAx application. For example, at step 330 the synchronization module 250 may, as part of the CAx client 240 in FIG. 2, detect creation of a feature of the engineering object within the proprietary CAx application. For example, the synchronization module 250 may detect creation of a proprietary feature 260 within the proprietary object file 255.

The synchronization module may detect creation of a feature of the engineering object within the proprietary CAx application in any suitable manner. In one embodiment, the synchronization module is a plugin for the CAx application, and detects creation of a feature of the engineering object using an application programming interface (API) provided by the CAx application that permits the execution of additional functions when a feature is created.

At step 340 of FIG. 3, the CAx client 240 that detected creation of the feature may insert a feature identifier corresponding to the feature within the model of the engineering object encoded in the proprietary format. For example, at step 340 synchronization module 250 may, as part of CAx client 240 in FIG. 2, insert feature identifier 265 corresponding to proprietary feature 260 within the proprietary representation of the engineering object stored in proprietary object file 255.

As used herein, the phrase “feature identifier” generally refers to a data item that relates a proprietary feature in a proprietary object file to a feature definition in a collaborative database. In one embodiment, the feature identifier is the index of the feature definition record in the collaborative database.

In one embodiment, the feature identifier is stored in a parameter for the feature within the proprietary representation of the engineering object. By storing the feature identifier within the proprietary representation of the engineering object, the relationship between the proprietary feature and the corresponding feature definition within the operations log is persistent between editing sessions on the CAx client. The feature identifier may be a globally unique identifier. In some embodiments, the feature identifier is represented in a text format to facilitate storage and retrieval within various CAx applications.

FIG. 4 is a schematic diagram of one example of a collaborative CAx editing system 400 that is consistent with one or more embodiments of the claimed invention. In addition to the internetwork 130 of the computing and communications infrastructure 100 of FIG. 1 and modules of the collaborative CAx editing system 200 of FIG. 2, collaborative CAx editing system 400 includes a second CAx client. Corresponding modules of the two CAx clients 240 are appended with reference letters ‘a’ and ‘b.’

In one embodiment, the proprietary representation and the operations log of the engineering object may be cached by the collaborative CAx server. For example, as part of collaborative CAx editing system 400 in FIG. 4, CAx server 210 may cache the proprietary representation of the engineering object in proprietary object cache 410. Regenerating a proprietary representation of an engineering object from sequentially-generated feature definitions in an operations log of the object may be a computationally-intensive and time-consuming process. Caching the proprietary representation of the engineering object on the CAx server with the operations log accelerates the loading of the engineering object on a CAx client on which the proprietary representation is usable by the CAx client and has not yet been loaded into memory (such as following a system crash of the CAx client, or when a new CAx client is added to the collaborative editing system).

In one embodiment, the proprietary representation of the engineering object may be provided to another (a second) CAx client. When the second CAx client adds or changes a feature in the proprietary representation, an instance of the synchronization module corresponding to the second client may communicate the feature identifier and a corresponding feature definition to the CAx server. The synchronization module (associated with the first CAx client) may then receive a feature identifier and the feature definition corresponding to the feature created on the second CAx client and create a corresponding local feature. For example, as part of collaborative CAx editing system 400, synchronization module 250b on CAx client 240b may create feature definition 220 in collaborative database 215 on CAx server 210. CAx server 210 may notify synchronization module 250a on CAx client 240a of the new feature in the collaborative database 215. Synchronization module 250a may then create synchronized feature 440 in proprietary object file 255a on CAx client 240a, corresponding to feature 260 in proprietary object file 255b on CAx client 240b.

In some embodiments, the CAx synchronization module may initiate insertion of a placeholder feature and corresponding feature reference within the operations log of the engineering object for features not directly supported by the operations log of the engineering object. For example, as depicted in collaborative editing system 400 in FIG. 4, proprietary feature 420 may be created in proprietary object file 255a on CAx client 240a. Synchronization module 250a may initiate creation of placeholder feature 430 and associated placeholder reference 435 in collaborative database 215 on CAx server 210. Features represented by a placeholder may not be editable by another CAx application, but the placeholder reference 435 maintains an association between the database record for placeholder feature 430 and the proprietary representation of the data in the proprietary object file 255a. Placeholder features may be referenced by other features. For example, a sheet body that could not be created or edited in collaborative database 215 may be represented by a placeholder feature and referenced by a split body feature.

As explained above, the collaborative CAx system may associate features in a proprietary representation of an engineering object with corresponding feature definitions in an operations log of the engineering object. A synchronization module, which may be a plug-in to a CAx application executing on a CAx client, may synchronize features between the proprietary and operations logs of the engineering object. As new features are created and edited on one CAx client and synchronized to the vendor-neutral database, synchronization modules on other CAx clients may synchronize the features from the vendor-neutral database to local copies of the model of the engineering object. The local copies of the model may be encoded in the same proprietary format or a different proprietary format.

The collaborative CAx editing system may maintain identifiers and references associating the proprietary and operations log representations of features of the engineering object in non-transitory storage, to prevent the loss of data in the event of system failure of either a CAx client or the CAx server. The feature identifiers help maintain data consistency within the various instances of the model of the engineering object. In some embodiments, additional or other data consistency techniques such as geometry identifiers or geometry identification may be applied such as those disclosed in commonly assigned co-pending U.S. patent application Ser. No. 14/185,823 entitled “SYSTEM AND METHODS FOR MULTI-USER CAX EDITING DATA CONSISTENCY” and filed on 20 Feb. 2014, which application is incorporated herein by reference.

The proprietary representation of an engineering object may be a “checkpoint” or point-in-time within a sequence of feature definitions created in operations log. Caching the proprietary representation of the engineering object in a proprietary object cache on the CAx server may facilitate faster recovery from the system failure of a CAx client. The synchronization module may bring the proprietary representation “up to date” by creating features in the proprietary representation that were created in the operations log subsequent to the point-in-time represented by the proprietary representation. However, proprietary point-in-time representations of the model of the engineering object are not essential to successful operation of the collaborative CAx system.

The various elements of the collaborative CAx system, method, and apparatus function cooperatively to facilitate productive collaborative CAx editing. The preceding depiction of the collaborative CAx system and other inventive elements described herein are intended to be illustrative rather than definitive. Similarly, the claimed invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a collaborative data store configured to store an object which can comprise a description, model, representation, arrangement or composition created by one or more contributors at any point from conception to completion wherein the object comprises a plurality of features and wherein the object is encoded in a vendor-neutral format;
a collaborative server configured to manage the collaborative data store;
a first computer or electronic device client comprising at least one processor and configured to execute a first software application and enable the first user to edit the content of the object encoded in a first proprietary format that is different than the vendor-neutral format; and
wherein the first computer or electronic device client and the collaborative server are collectively configured to detect updates to the content of the object encoded in the first proprietary format, convert the updates to feature changes and update the object encoded in the vendor-neutral format with the feature changes.

2. The system of claim 1, wherein the third party neutral format is an operations log.

3. The system of claim 1, wherein each operation of the operations log corresponds to a feature of the plurality of features.

4. The system of claim 1, comprising a second computer or electronic device client comprising at least one processor and configured to execute a second computer or electronic device application and enable the second user to edit the content of the object encoded in a second proprietary format that is different than the vendor-neutral format.

5. The system of claim 2, wherein the vendor-neutral format encompasses the first proprietary format and the second proprietary format.

6. The system of claim 1, wherein second computer or electronic device client and the collaborative server are collectively configured to detect feature changes in the content of the object encoded in the vendor-neutral format, convert the feature changes to updates for the content of the object encoded in the second proprietary format and execute the updates to the content of the object encoded in the second proprietary format.

7. The system of claim 1, wherein a feature corresponds to a plurality of descriptive elements within the content of the object encoded in the first proprietary format or the second proprietary format.

8. The system of claim 1, wherein the collaborative data store is a database.

9. A computer- or electronic device-implemented method comprising:
storing the content of an object comprising a plurality of features and encoded in a vendor-neutral format within a collaborative data store;
detecting updates to the content of the object stored on a first computer or electronic device client and encoded in a first proprietary format;
converting the updates to feature changes; and
updating the content of the object encoded in the vendor-neutral format with the feature changes.

10. The method of claim 9, wherein the vendor-neutral format is an operation log.

11. The method of claim 10, wherein each operation of the operations log corresponds to a feature of the plurality of features.

12. The method of claim 9, further comprising enabling a second user to edit the content of the object encoded in a second proprietary format.

13. The method of claim 12, wherein the vendor-neutral format encompasses the first proprietary format and the second proprietary format.

14. The method of claim 12, further comprising detecting feature changes for the content of the object encoded in the vendor-neutral format, converting the feature changes to updates for the content of the object encoded in the second proprietary format, and executing the updates for the content of the object encoded in the second proprietary format.

15. The method of claim 9, wherein a feature corresponds to a plurality of descriptive elements within the content of the object encoded in the first proprietary format or the second proprietary format.

16. The method of claim 9, wherein the collaborative data store is a database.

17. A non-transitory computer- or electronic device-readable medium comprising one or more computer- or electronic device-executable instructions that, when executed by a computing device, cause the computing device to:
store content of an object comprising a plurality of features and encoded in a vendor-neutral format within a collaborative data store;
detect updates to the content of the object stored on a first software or electronic device client and encoded in a first proprietary format;
convert the updates to feature changes; and
update the content of the object or element encoded in the vendor-neutral format with the feature changes.
